(19) United States
(12) Patent Application Publication
(10) Pub. No.: US 2009/0295589 A1
(43) Pub. Date: Dec. 3, 2009

(54) CONNECTOR APPARATUS

(75) Inventors: ZHEN-DONG WU, Shenzhen City (CN); REN-ZHONG WEI, Shenzhen City (CN); HAI-LIANG WANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/181,389

(22) Filed: Jul. 29, 2008

(30) Foreign Application Priority Data
May 30, 2008 (CN) 200810301881.5

(51) Int. Cl. G08B 21/00

(52) U.S. Cl. 340/635

(57) ABSTRACT

A connector apparatus (100) having an alarm function is described. A connector (10) can be connected to an electronic device and generate a pulse signal. A number of the pulse signal is a time of plugging and unplugging of the connector. A micro control unit (30) is electronically connected to the connector and receives the pulse signal. The micro control unit counts the number of the pulse signal, and a number of plugging and unplugging of the connector is predetermined thereby. A display module (50) is electronically connected to the micro control unit and used for displaying the number of the pulse signal. An alarm unit (70) is electronically connected to the micro control unit, when the number of the pulse signal reaches the predetermined number, the micro control unit sends a caution signal to the alarm unit, and the alarm unit generates a warning signal.

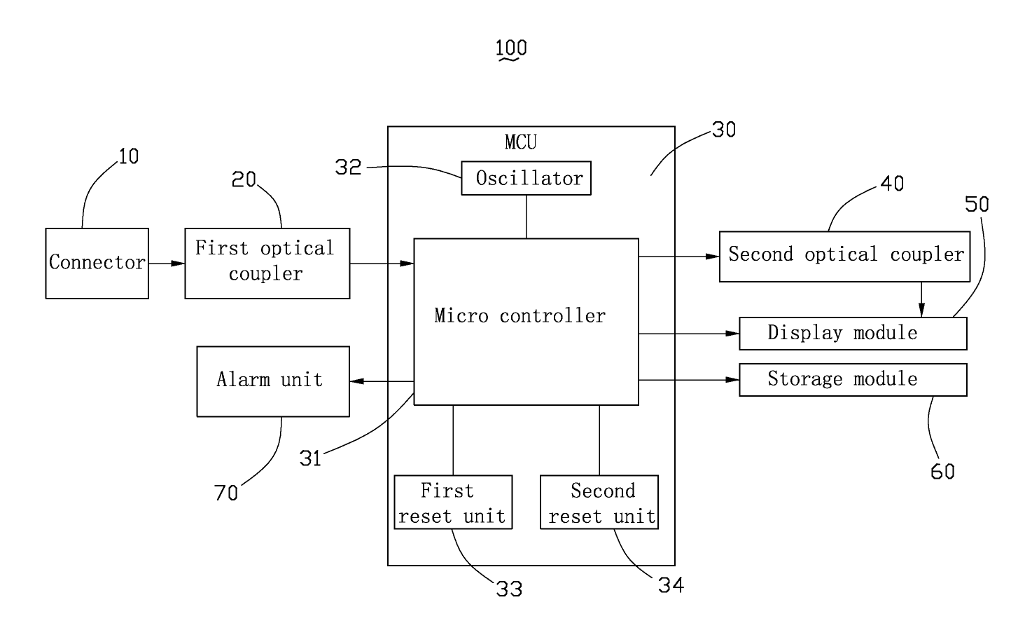

### BACKGROUND OF THE INVENTION

1. Field of the Invention

The present invention generally relates to connector apparatuses, and particularly to a connector apparatus having an alarm function.

2. Description of Related Art

With the development of wireless communication and information processing technologies, electronic devices, such as computers, mobile phones and personal digital assistants (PDAs), are now in widespread use. During production and assembly, various performance levels of the electronic devices are tested. During testing, the electronic devices are usually connected to a tester through a connector.

However, after repeated usage of the connector (“plugging and unplugging”), the connector may become damaged and test results may become erroneous and/or inaccurate.

Therefore, a connector apparatus having an alarm function is desirable to overcome the above-described problems.

### BRIEF DESCRIPTION OF THE DRAWINGS

Many aspects of the connector apparatuses can be better understood with reference to the drawing. The drawing is not necessarily drawn to scale, the emphasis instead being placed upon clearly illustrating the principles of the present connector apparatus.

The drawing is a block diagram of a connector apparatus according to an examplary embodiment of the invention.

### DETAILED DESCRIPTION OF THE EMBODIMENTS

Referring to the drawing, an exemplary embodiment of a connector apparatus 100 is shown. The connector apparatus 100 is used for connecting an electronic device (not shown) to be tested to a testing device (not shown). The connector apparatus 100 includes a connector 10, a first optical coupler 20 electronically connected to the connector 10, a micro-control unit (MCU) 30, a second optical coupler 40, a display module 50, a storage module 60 and an alarm module 70. The first optical coupler 20, the second optical coupler 40, the display module 50, the storage module 60 and the alarm module 70 are electronically connected to the MCU 30.

The MCU 30 includes a micro controller 31, an oscillator 32, a first reset unit 33 and a second reset unit 34. The oscillator 32, the first reset unit 33 and the second reset unit 34 are electronically connected to the micro controller 31. The oscillator 32 is a clock source of the micro controller 31 for generating clock signals to the micro controller 31.

For a connector 10, there is usually a predetermined number of plugging and unplugging operations that can be done (“fault limit”), before the connector 10 may become or be damaged. This predetermined number of plugging and unplugging operations pre-set in the micro controller 31.

Each time the connector 10 is connected an electronic device being tested, a pulse signal is generated and sent to the MCU 30 through the first optical coupler 20. The first optical coupler 20 herein is used for transmitting the pulse signal to the MCU 30, and isolating the pulse signal to avoid interference by external signals. The micro controller 31 receives the pulse signals from the first optical coupler 20, and accumulates the number of pulse signals received.

The micro controller 31 sends the cumulative number of pulse signal and a driving signal to the display module 50 through the second optical coupler 40, so the cumulative number of the pulse signals is displayed by the display module 50. The second optical coupler 40 is configured for sending the accumulated number of pulse signal and the driving signal to the display, and preventing the display module 50 from instability due to interference between external signals and the driving signal.

Additionally, the micro controller 31 sends the cumulative number of pulse signals to the storage module 60. The storage module 60 stores the number of pulse signals received from the micro controller 31. The storage module 60 safeguards against power failure. If the connector apparatus 100 is unexpectedly powered off or has its operation interrupted, the storage module 60 can save the stored number of pulse signals. The number of pulse signals after the reactivation of the connector 10 can be added to the number of pulse signals recorded in the storage module 60.

When the number of pulse signals received by the micro controller 31 exceeds the fault limit pre-set in the micro controller 31, the micro controller 31 sends a caution signal to the alarm unit 70. The alarm unit 70 generates a warning signal to denote that the cumulative number of plugging and unplugging number of the connector 10 has reached the fault limit, and the connector 10 should be replaced by a new connector.

When a new connector is used, the first reset unit 33 sends a reset signal to the micro controller 31, the micro controller 31 reset the cumulative number of plugging and unplugging of the connector 10 to zero.

If the connector apparatus 100 is unexpectedly powered off or has its operation interrupted, the second reset unit 34 is used to power on and reset the micro controller 31, so that when the micro controller 31 works again, it can return to the pulse count before it was powered off or terminated.

It should be understood that, the first optical coupler 20 can be omitted, the pulse signal can be sent directly from the connector 10 to the MCU 30. The second optical coupler 30 can also be omitted, the number of the pulse signals and the driving signal can be sent directly from the micro controller 31 to the display module 50.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A connector apparatus comprising:
a connector, used for connecting to an electronic device and generating a pulse signal each time the electronic device is plugged and unplugged from the connector;
a micro control unit electronically connected to the connector and receiving the pulse signals from the connector, the micro control unit accumulating the total number of pulse signals, a predetermined number of plugging and unplugging operations of the connector before replacement of the connector being pre-set into the micro control unit;
a display module electronically connected to the micro control unit and used for displaying the number of pulse signals when receiving a driving signal from the micro control unit; and
an alarm unit electronically connected to the micro control unit, when the number of the pulse signal reaches the predetermined number, the micro control unit sending a caution signal to the alarm unit, and the alarm unit generating a warning signal.

2. The connector apparatus of claim 1, further comprising a storage module electronically connected to the micro control unit for storing the number of pulse signals received by the micro control unit.

3. The connector apparatus of claim 2, wherein the storage module safeguards against power failure.

4. The connector apparatus of claim 1, further comprising a first optical coupler electronically connected to the connector, the first optical coupler for sending the pulse signal from the connector to the micro control unit.

5. The connector apparatus of claim 1, further comprising a second optical coupler electronically connected between the micro control unit and the display module, the second optical coupler for sending the driving signal from the micro control unit to the display module.

6. The connector apparatus of claim 1, wherein the micro control unit comprises a micro controller and an oscillator, the oscillator being a clock source of the micro controller for generating clock signals to the micro controller.

7. The connector apparatus of claim 6, wherein the micro control unit further comprises a first reset unit electronically connected to the micro controller for resetting the number of pulse signal sent by the connector to zero.

8. The connector apparatus of claim 6, wherein the micro control unit further comprises a second reset unit electronically connected to the micro controller for power on resetting the micro controller.
